(19) United States
(12) Patent Application Publication
(10) Pub. No.: US 2007/0028901 A1
(43) Pub. Date: Feb. 8, 2007

(54) Exhaust gas recirculation system for internal combustion engine having superchargers

(75) Inventors: Ichiyoshi Watakabe, Kariya-city (JP); Osamu Shimane, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/489,439

(22) Filed: Jul. 20, 2006

(30) Foreign Application Priority Data
Aug. 2, 2005 (JP) 2005-223607

(51) Int. Cl. F02M 25/07; F02B 47/08; F02B 33/44

(52) U.S. Cl. 123/568.12; 123/568.2; 60/605.2

(57) ABSTRACT

A first EGR pipe and a second EGR pipe are merged at a confluent portion. A three-way valve is disposed in the confluent portion to interrupt a communication between the first and the second EGR pipe. An EGR gas cooler is disposed upstream of EGR control valves. Exhaust gas pulsations in the first exhaust pipe and the second exhaust pipe do not interfere with each other even if the phase of the pulsations are quit opposite. Thus, the exhaust gas pressure working on turbines of turbocharger can be increased to enhance a supercharging efficiency.

### CROSS REFERENCE TO RELATED APPLICATIONS

This application is based on Japanese Patent Applications No. 2005-223607 filed on Aug. 02, 2005, the disclosure of which is incorporated herein by reference.

### FIELD OF THE INVENTION

The present invention relates to an exhaust gas recirculation system for an internal combustion engine having a supercharger. Especially, the exhaust gas recirculation system has multiple exhaust gas recirculation control valves which are respectively provided to each of multiple banks, and has multiple turbochargers which are respectively provided to each of the multiple banks.

### BACKGROUND OF THE INVENTION

JP-9-137754A and JP-10-61503A show an exhaust gas recirculation system which is installed in a V-type engine. The engine includes two banks in which multiple cylinders are arranged. The engine includes a turbocharger, multiple exhaust gas recirculation pipes (EGR pipes), and multiple exhaust gas recirculation control valves (EGR valves) which respectively open/close the EGR pipes.

JP-2003-120354A (U.S. Pat. No. 6,917,873 B2) shows an exhaust gas recirculation system for a V-type engine. The engine includes two superchargers, an EGR pipe for recirculating a part of exhaust gas into an intake passage, and an EGR valve which opens/closes the EGR pipe.

### RELATED ART

FIG. 3 shows a related art of an exhaust gas recirculation system for a V-type engine. Turbochargers 101, 102 are respectively provided to each of banks 103, 104. A first exhaust gas recirculation pipe (first EGR pipe) 105 is connected to the first exhaust manifold 113, and a second exhaust gas recirculation pipe (second EGR pipe) 106 is connected to the second exhaust manifold 114. The first EGR pipe 105 communicates with the second EGR pipe 106 at a confluent portion 115. An EGR gas cooler 107 cooling the exhaust gas is arranged downstream of the confluent portion 115. A first EGR valve 111 and a second EGR valve 112 are arranged downstream of the EGR gas cooler 107. The first and the second EGR valve 111, 112 adjust the amount of exhaust gas recirculating from the first and the second EGR pipe 105, 106 to an intake passage.

When the first and the second EGR valve 111, 112 are opened, the exhaust gas flows from the first and the second exhaust manifold 113, 114 to the intake passage through the first and the second EGR passage 105, 106, the confluent portion 115, and the EGR gas cooler 107.

When the first and the second EGR valve 111, 112 are closed, the exhaust gas does not flow into the intake passage. However, the EGR gas flowing through the first EGR passage 105 and the EGR gas flowing through the second EGR passage 106 are merged at the confluent portion 115. Hence, the exhaust gas pulsations generated in each of the exhaust manifold 113, 114 interfere with each other, so that the exhaust gas energy, especially, exhaust gas pressure is reduced. Since the turbochargers 101, 102 are driven by the exhaust gas energy, a recovery efficiency of the exhaust gas energy is decreased and a supercharging efficiency is deteriorated when the exhaust gas pressure working on turbines of the turbochargers 101, 102 is decreased.

### SUMMARY OF THE INVENTION

The present invention is made in view of the foregoing matter and it is an object of the present invention to provide an exhaust gas recirculation system for an internal combustion engine having multiple superchargers capable of improving a charging efficiency of an intake air and supercharging efficiencies of turbochargers.

According to the present invention, an exhaust gas recirculation system includes a plurality of exhaust gas recirculation pipes defining exhaust gas recirculation passages, an exhaust gas recirculation control valves for controlling an amount of exhaust gas flowing through the exhaust gas recirculation pipes. The system further includes an exhaust gas cooling apparatus disposed upstream of the exhaust gas recirculation control valves for cooling the exhaust gas, and a shutoff valve disposed upstream of the exhaust gas cooling apparatus for interrupting a communication between the exhaust recirculation passages in a situation that the exhaust gas recirculation control valves are fully closed.

### BRIEF DESCRIPTION OF THE DRAWINGS

The above and other objects, features, and advantages of the present invention will become more apparent from the following detailed description made with reference to the accompanying drawings, in which like parts are designated by like reference number and in which:

FIG. 1 is a schematic view of an exhaust gas recirculation system;

FIG. 2 is a schematic view of the exhaust gas recirculation system; and

FIG. 3 is a schematic view showing a related art of an exhaust gas recirculation system.

### DETAILED DESCRIPTION OF THE PREFERRED EMBODIMENTS

Embodiments of the present invention will be described hereinafter with reference to the drawings.

### First Embodiment

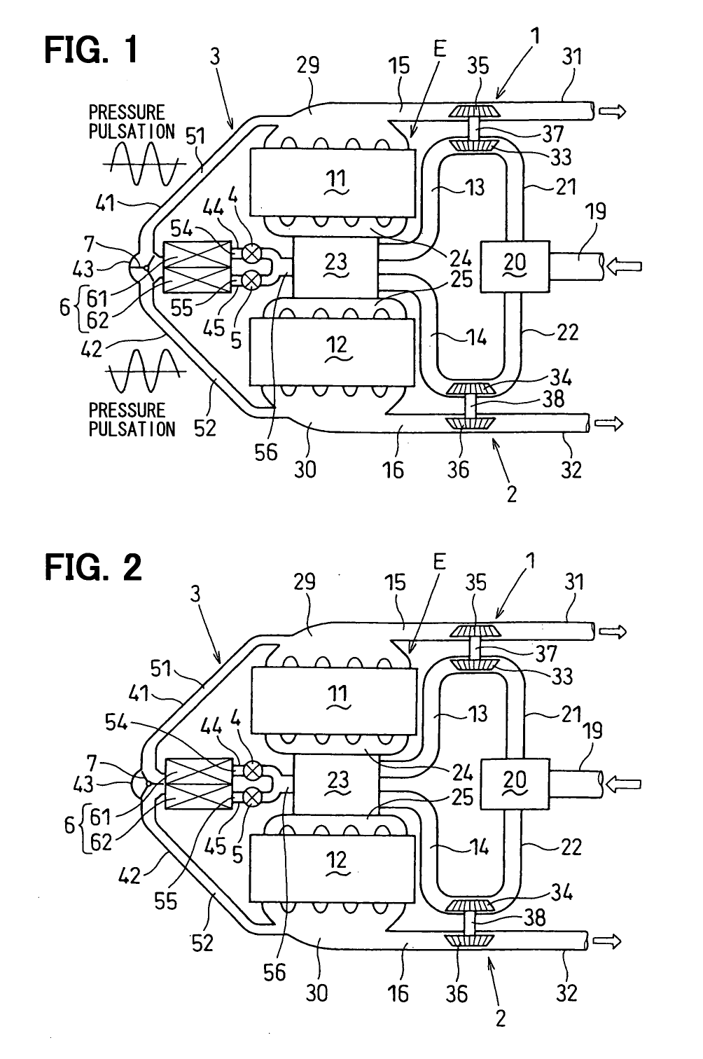

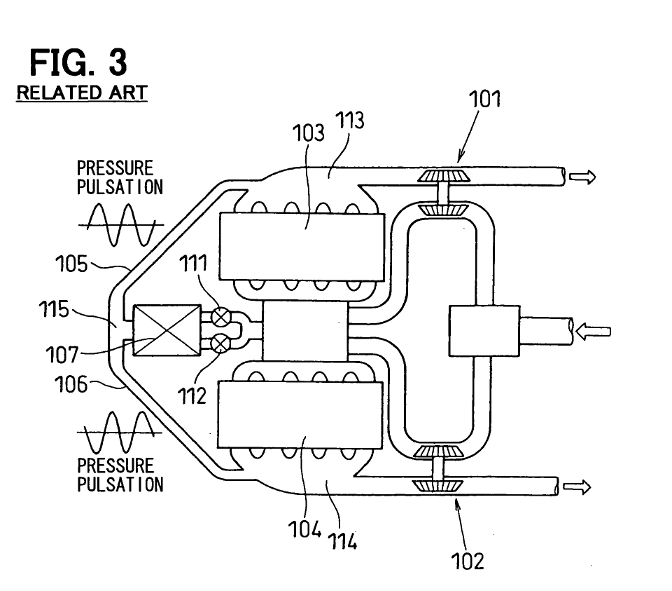

FIG. 1 is a schematic view of an exhaust gas recirculation system for an internal combustion engine E having a first turbocharger 1 and a second turbocharger 2. The engine E is a V-type engine having an exhaust gas recirculation system 3 for recirculating a part of exhaust gas into an intake pipe. The exhaust gas recirculation system 3 is provided with a first exhaust gas recirculation control valve 4 and a second exhaust gas recirculation control valve 5. The exhaust gas recirculation system 3 is referred to the EGR system 3, the exhaust gas recirculation control valve 4, 5 are referred to as the EGR valve 4, 5, and the recirculated exhaust gas is referred to as the EGR gas, hereinafter.

The EGR valve 4, 5 control the amount of EGR gas flowing in the EGR system 3. The EGR system 3 is provided with an exhaust gas cooling apparatus 6 upstream of the EGR valve 4,5. The exhaust gas cooling apparatus 6 is referred to as the EGR gas cooler 6, hereinafter. A three-way valve 7 is provided upstream of the EGR gas cooler 6.

The V-type engine E is a direct injection type diesel engine, which has a first bank 11 and a second bank 12 in each of which a plurality of cylinders are mounted. The first bank 11 and the second bank 12 are arranged in a V-shape with respect to a crankshaft (not shown). The engine E is not limited to V-type engine. The engine E can be the other type engine having a multiple banks.

The engine E is respectively provided with intake valves (not shown) and exhaust valves (not shown) in the first bank 11 and the second bank 12, corresponding to each cylinder. The engine E is provided with a first intake passage 13 and a second intake passage 14, which are respectively connected with the first bank 11 and the second bank 12. The engine E is provided with a first exhaust passage 15 and a second exhaust passage 16, which are respectively connected with the first bank 11 and the second bank 12.

The first intake passage 13 and the second intake passage 14 are respectively defined by a common pipe 19, an air cleaner 20, a first and a second intake pipes 21, 22, a surge tank 23, and a first and a second intake manifold 24, 25. The first exhaust passage 15 and the second exhaust passage 16 are defined by a first and a second exhaust manifold 29, 30, and a first and a second exhaust pipe 31, 32.

The engine E is provided with a first turbocharger 1 and a second turbocharger 2. The engine E is further provided with an exhaust gas recirculation apparatus, which is referred to as the EGR apparatus.

The first turbocharger 1 and the second turbocharger 2 are respectively comprised of a first and a second compressor 33, 34, and a first and a second turbine 35, 36. The first compressor 33 and the first turbine 35 are connected with each other through a first turbine shaft 37. The second compressor 34 and the second turbine 36 are connected with each other through a second turbine shaft 38. An intercooler for cooling air compressed by the first and the second compressor 33, 34 may be provided in the first and the second intake pipe 21, 22.

The first and the second compressor 33, 34 respectively include multiple compressor blades which respectively rotate in the first and the second intake pipe 21, 22. The first and the second turbine 35, 36 respectively include multiple turbine blades. The first turbocharger 1 and the second turbocharger 2 have the well-known functions.

The EGR system 3 includes the first and the second exhaust manifold 29, 30, a first and a second EGR pipe 41, 42, a confluent pipe 43, and a third and a fourth EGR pipe 44, 45. The third and the fourth EGR pipe 44, 45 are respectively connected to the surge tank 23. The first and the second EGR pipe 41, 42 define a first EGR passage 51 and a second EGR passage 52 therein.

The confluent pipe 43 defines a valve chamber which accommodates the three-way valve 7. The confluent pipe 43 includes a first inlet for introducing the EGR gas from the first EGR passage 51 into the valve chamber, a second inlet for introducing the EGR gas from the second EGR passage 52 into the valve chamber. The confluent pipe 43 further includes an outlet port for introducing the EGR gas from the valve chamber toward the EGR gas cooler 6.

The third and the fourth EGR pipe 44, 45 respectively define a third and a fourth EGR passage 54, 55 therein. The third and the fourth EGR pipe 44, 45 are converged at a confluent passage 56, which is connected to the surge tank 23. The confluent passage 56 can be omitted so that the third and the fourth EGR pipe 44, 45 are directly connected to the surge tank 23.

The first and the second EGR valve 4, 5 are respectively comprised of a housing, a valve body accommodated in the housing, a valve shaft rotating with the valve body, and a valve biasing means, such as a spring, for biasing the valve body in an opening direction or a closing direction. The EGR valves 4, 5 can be poppet valves or butterfly valves. Each EGR valve 4, 5 is driven by an electric actuator including an electric motor (not shown) and a power transmitting mechanism (not shown).

The first and the second EGR valve 4, 5 adjust an opening area of the third and the fourth EGR passage. A valve bearing is provided in the housing to support the valve shaft through a bushing, a ball bearing, and an oil seal. The oil seal restrict leak of lubricant lubricating the valve bearing. The third and the fourth EGR passage 54, 55 are defined in a single housing. Alternatively, the third and the fourth EGR passage 54, 55 are respectively defined in different housings.

The EGR gas cooler 6 heat-exchanges between high-temperature EGR gas flowing out from the first and the second EGR passage 51, 52 and low-temperature engine coolant. The EGR gas cooler 6 is comprised of a first cooler 61 and a second cooler 62. Each cooler 61, 62 has an inlet tank and an outlet tank. Multiple tubes connect the inlet tank with the outlet tank. The high-temperature EGR gas flows through the multiple tubes. The multiple tubes are accommodated in a casing. The low-temperature engine coolant flows in the casing. The EGR gas from the first exhaust manifold 29 flows through the first EGR passage 51, the confluent pipe 43, the first cooler 61, the third EGR passage 54, and the confluent passage 56. The EGR gas from the second exhaust manifold 30 flows through the second EGR passage 52, the confluent pipe 43, the second cooler 62, the fourth EGR passage 55 and the confluent passage 56.

An inner fin is provided in each tube of the EGR gas cooler 6 to improve heat-exchange efficiency. The casing, the tubes, and the inner fins are made from stainless steal and are assembled together by brazing. The EGR gas has a temperature of 400-500° C. and contains sulfide, nitric acid, sulfuric acid, ammonium ion, acetic acid, and the like. Stainless steel has heat resistance and corrosion resistance.

The engine E has an engine coolant passage therein. The engine coolant passage is connected with the EGR cooler 6 through a pipe (not shown). The EGR cooler 6 is connected with a radiator (not shown) through another pipe. The engine coolant from the coolant passage flows through the pipe, the EGR cooler 6, another pipe, and the radiator, and returns to the coolant passage. This engine coolant flow is produced by a water pump mounted on the engine E.

The three-way valve 7 is comprised of a rotary valve body and a valve shaft. A valve driving apparatus for driving the three-way valve 7 is comprised of an electric motor and a power transmitting mechanism. The electric motor is controlled by an electric control unit (ECU).

The valve body of the three-way valve 7 is Y-shaped in its cross section. When the first and the second EGR valve 4, 5 are not energized to close the third and the fourth EGR passage 54, 55, the three-way valve 7 closes the first EGR passage 51 and the second EGR passage 52 as shown in FIG. 1. When the first and the second EGR valve 4, 5 are energized to open the third and the fourth EGR passage 54, 55, the three-way valve 7 opens the first EGR passage 51 and the second EGR passage 52, so that the first and the second EGR passage 51, 52 are respectively connected to the first cooler 61 and the second cooler 62, as shown in FIG. 2. The situation shown in FIG. 1 is referred to as a first mode, and the situation shown in FIG. 2 is referred to as a second mode.

The ECU is a microcomputer including a CPU, a ROM, a RAM, an input circuit, and an output circuit. When an ignition switch (not shown) is turned ON, the ECU controls the positions of the first and the second EGR valve 4, 5 and the three-way valve 7 according to a control program stored in the memory. Sensor signals from an EGR amount sensor, a crank angle sensor, an accelerator position sensor, an airflow meter, and a coolant temperature sensor are inputted into the microcomputer.

(Operation of the First Embodiment)

When the engine E is operated, the fresh air is introduced into each cylinder on the first and the second bank 11, 12 through the first intake passage 13 and the second intake passage 14. The exhaust gas burned in each cylinder is expelled through the first and the second exhaust passage 15, 16. The first and the second turbine 35, 36 are driven by an exhaust gas energy so that the first and the second compressor 33, 34 are rotated, whereby the intake air flowing through the first and the second intake passage 13, 14 is supercharged into each cylinder.

The ECU controls the first and the second EGR valve 4, 5 and the three-way valve 7 according to the engine speed and the engine load (for example, accelerator position). When the engine E is in high-load, the valves 4, 5, 7 are positioned in the first mode shown in FIG. 1. When the engine E is in middle-load or low-load, the valves 4, 5, 7 are positioned in the second mode shown in FIG. 2, so that the EGR gas is introduced into the EGR gas cooler 6 from the first and the second exhaust passage 15, 16 through the first and the second EGR passage 51, 52.

When the engine is in low-load or middle-load, the valves 4, 5, 7 are turned into the second mode. The EGR gas is cooled by the engine coolant in the first cooler 61 and the second cooler 62, and then flows into the surge tank 23 through the first and the second EGR valve 4, 5, the third and the fourth EGR passage 54, 55, and the confluent passage 56. The cooled EGR gas is mixed with the intake air, and then introduced into each cylinder. The first and the second EGR valve 4, 5 adjust an EGR ratio to reduce NOx without deteriorating the output of the engine E.

When the engine E is in the high-load, the valves 4, 5, 7 are turned into the first mode. The first EGR passage 51 and the second EGR passage 52 are isolated from each other, whereby exhaust gas pulsations in the first exhaust passage 15 and the second exhaust passage 16 do not interfere with each other.

(Effect of the First Embodiment)

Since the three-way valve 7 is disposed in the confluent pipe 43, the exhaust gas pulsation in the first exhaust passage 15 and the second exhaust passage 16 do not interfere with each other even if the phase of the pulsations are quit opposite as shown in FIG. 1. Thus, the first turbine 35 receives no effect from the second turbine 36, whereby the exhaust gas pressure applied to the first and the second turbine 35, 36 can be increased to enhance a supercharging efficiency. According as the supercharging efficiency increases, a charging efficiency of intake air increases, so that the exhaust gas amount is increased to increase the exhaust gas pressure. The supercharging efficiency is further increased.

When the engine E is in low-load or middle-load, the valve 4, 5, 7 are turned to the second mode as shown in FIG. 2. The EGR gas is cooled by the first cooler 61 and the second cooler 62, and then, recirculated into the surge tank 23. Thereby, the charging efficiency of the intake air is improved to enhance the output of the engine E.

Since the EGR gas cooler is disposed upstream of the EGR valves 4, 5, the bearing of the EGR valves 4, 5 hardly receives heat from the EGR gas. Hence, it is possible to restrict a deterioration of the oil seal or packing provided in the EGR valves 4, 5.

(Modification)

The valve driving apparatus driving the EGR valves 4, 5 and the three-way valve 7 can be comprised of a negative-pressure-operated actuator, or an electromagnetic actuator.

The EGR gas cooler 6 can be provided with a bypass passage bypassing the EGR gas cooler 6. The EGR gas flows through both of the EGR gas cooler 6 and the bypass passage. In the above embodiment, the three-way valve 7 is provided in the confluent pipe 43. Instead of the three-way valve 7, a switching valve opening/closing at least one of the first and the second EGR passage 51, 52 can be used. This switching valve is operated by an electric actuator, a negative-pressure-operated actuator, or an electromagnetic actuator. In the above embodiment, the first and the second EGR valve 4, 5 are provide. The EGR valve can be comprised of a single valve, or more than three valves. The third and the fourth EGR passage 54, 55 can be formed by a single pipe or more than three pipes. The first cooler 61 and the second cooler 62 can be combined to a single EGR gas cooler. Alternatively, the EGR gas cooler 6 can be divided into more than three gas coolers.

What is claimed is:

1. An exhaust gas recirculation system for an internal combustion engine having superchargers, the internal combustion engine including a plurality of banks in which at least one cylinder is arranged and a plurality of exhaust passages which are individually connected to each of the banks, the exhaust gas recirculation system comprising:
a plurality of turbochargers, each of which has a turbine respectively disposed in the exhaust passages and has a compressor supercharging an intake air into each cylinder, the turbine and the compressor being connected with each other, the turbine being driven by an exhaust gas flowing through the exhaust passages;
a plurality of exhaust gas recirculation pipes defining exhaust gas recirculation passages which are individually connected with the exhaust passages, the exhaust gas recirculation pipes introducing a part of exhaust gas from the exhaust passages to an intake passage;
an exhaust gas recirculation control valve for controlling an amount of exhaust gas flowing through the exhaust gas recirculation pipes;
an exhaust gas cooling apparatus disposed upstream of the exhaust gas recirculation control valves for cooling the exhaust gas; and
a shutoff valve disposed upstream of the exhaust gas cooling apparatus for interrupting a communication between the exhaust recirculation passages in a situation that the exhaust gas recirculation control valves are fully closed.

2. The exhaust gas recirculation system according to claim 1, wherein
the plurality of banks are comprised of a first bank and a second bank,
the plurality of exhaust passages are comprised of a first exhaust passage and a second exhaust passage, each of which respectively communicating with the cylinders in the first bank and the second bank;
the plurality of exhaust gas recirculation passages are comprised of a first exhaust gas recirculation passage and a second exhaust gas recirculation passage, each of which respectively communicating with the first exhaust passage and the second exhaust passage.

3. The exhaust gas recirculation system according to claim 2, wherein
the first exhaust gas recirculation passage and the second exhaust gas recirculation passage are merged at a confluent portion.

4. The exhaust gas recirculation system according to claim 3, wherein
the shutoff valve is a switching valve which is switched between a first position in which the first and the second exhaust gas recirculation passage communicate with each other and a second position in which the first and the second exhaust gas recirculation passage are interrupted with each other.

5. The exhaust gas recirculation system according to claim 3, wherein
the shutoff valve is a switching valve which opens/closes at least one of the first and the second exhaust gas recirculation passage.

6. The exhaust gas recirculation system according to claim 1, wherein
the exhaust gas recirculation control valves include a housing forming a part of the exhaust gas recirculation pipe, a valve body rotatably accommodated in the housing, and a valve shaft rotating with the valve body, and
the housing includes a bearing portion which slidably or rotatably supports the valve shaft.

7. An exhaust gas recirculation system for an internal combustion engine having superchargers, the internal combustion engine including a plurality of exhaust passages, the exhaust gas recirculation system comprising:
a plurality of turbochargers, each of which has a turbine respectively disposed in the exhaust passages and has a compressor supercharging an intake air into each cylinder, the turbine and the compressor being connected with each other, the turbine being driven by an exhaust gas flowing through the exhaust passages;
a plurality of exhaust gas recirculation pipes defining exhaust gas recirculation passages which are individually connected with the exhaust passages, the exhaust gas recirculation pipes introducing a part of exhaust gas from the exhaust passages to an intake passage;
an exhaust gas recirculation control valve for controlling an amount of exhaust gas flowing through the exhaust gas recirculation pipes; and
a shutoff valve for interrupting a communication between the exhaust recirculation passages in a situation that the exhaust gas recirculation control valves are fully closed.
